(19) United States
(12) Patent Application Publication
(10) Pub. No.: US 2024/0049820 A1
(43) Pub. Date: Feb. 15, 2024

(54) A METHOD OF ATTACHING AT LEAST TWO PIECES OF FABRIC AND A FOOTWEAR COMPRISING A MEMBRANE

(71) Applicant: ECCO Sko A/S, Bredebro (DK)

(72) Inventor: Frank Jensen, Bredebro (DK)

(21) Appl. No.: 18/269,263

(22) PCT Filed: Dec. 23, 2021
(86) PCT No.: PCT/DK2021/050383

§ 371 Date: Jun. 22, 2023

(30) Foreign Application Priority Data
Dec. 23, 2020 (DK) PA 2020 70873

(51) Int. Cl. A41D 27/24; A41D 31/102; A43B 7/12; B29C 65/08; B29C 65/50

(52) U.S. Cl. CPC A41D 27/245; A41D 31/102; A43B 7/125; B29C 65/08; B29C 65/5042

(57) ABSTRACT

A method of attaching at least two pieces of fabric in a waterproof fabric product. The at least two pieces of fabric are attached at a seam. The seam subsequently is sealed by application of a sealing tape. The method includes attaching the at least two pieces of fabric to each other by a welding process to form a welded seam, and performing the sealing by applying the sealing tape to cover the welded seam at one side of the fabric. A waterproof fabric product that has been produced using the method of attaching at least two pieces of fabric. A footwear includes a membrane including at least two pieces of fabric that are attached at a seam.

### FIELD OF THE INVENTION

The invention relates to a method of attaching at least two pieces of fabric in a waterproof fabric product.

Furthermore, the invention relates to a waterproof fabric product that has been produced using the method of attaching at least two pieces of fabric in a waterproof fabric product according to the invention.

Even further, the invention relates to a footwear comprising a membrane wherein the membrane comprises at least two pieces of fabric that are attached at a seam.

### BACKGROUND OF THE INVENTION

In connection with waterproof fabric constructions such as e.g. waterproof footwear, pieces of fabric that may serve as a membrane to facilitate waterproofness, may be attached to each other in the construction. In order to ensure that the waterproof fabric constructions, e.g. waterproof footwear, fulfil the waterproof requirements, instructions for attaching the fabrics to each other must be followed, e.g. instructions as specified by e.g. a supplier of the fabrics.

Thus, in the prior art waterproof fabric constructions, the waterproof fabrics are attached edge to edge by stitching, e.g. by zigzag, flatlock or blind-seam stitching, where the stitched seam subsequently is sealed with a 3-layer sealing tape comprising a rear mesh, a membrane and a layer of adhesive, and where the 3-layer sealing tape has a width of 22 millimetre in order to ensure that holes in the fabrics made by the stitching are resealed and that there will be sufficient allowance of the tape on both sides of the stitching area.

A further example of a water-resistant fabric having a seam and a method of making such a seam is disclosed by EP 2454958 A1. This document discloses that a first piece of laminated fabric, a second piece of laminated fabric and one or more strips of adhesive hydrostatic polymer are provided and stacked along a common border with the one or more strips of adhesive hydrostatic polymer placed between the first and the second piece of laminated fabric. Ultrasonic energy is applied to the stack of fabrics and strip(s) of adhesive hydrostatic polymer along a common border such that the adhesive strip(s) is(are) melted. The melted adhesive from the adhesive hydrostatic polymer strips is allowed to flow and attach the first and the second piece of laminated fabric, thereby forming a seam. Subsequently, the seam can be opened and a seam tape is applied at one side along at least a portion of the seam, e.g. to form a more effective hydrostatic barrier. According to this example of making a seam involving laminated fabrics, strips of adhesive hydrostatic polymer must be added in order to provide a seam for attaching the first and the second piece of laminated fabric.

### SUMMARY OF THE INVENTION

According to a first aspect, the invention relates to a method of attaching at least two pieces of fabric in a waterproof fabric product, whereby the at least two pieces of fabric are attached at a seam and whereby the seam subsequently is sealed by application of a sealing tape, said method comprising
attaching the at least two pieces of fabric to each other by a welding process to form a welded seam, and
performing said sealing by applying said sealing tape to cover said welded seam at one side of the fabric.

Hereby, the attaching of the at least two pieces of fabric together may be made in such a manner that any stitching may be avoided and thus in such a manner that it may be avoided to pierce the fabrics where any stitching threads otherwise would pass through the fabrics. Hence, a plurality of holes in the fabrics, e.g. in a range of 4-6 or even more holes per cm on each side of the seam may be avoided and thus it may be achieved that the subsequent sealing by a sealing tape may be made in a more cost-efficient manner, e.g. by means of a sealing tape of reduced width or by means of a sealing tape that does not necessarily fulfil the otherwise stringent requirements that have been prescribed according to the prior art. Thus, a certain degree of flexibility may be achieved when choosing the sealing tape used for the seam sealing, which may reduce costs noticeably. Furthermore, it is noted that the attaching method of using a welding process has the advantage that such a process may be performed without e.g. reducing the waterproof characteristics of the involved fabrics, e.g. without making holes, pinholes, punctures, etc. in the fabrics. Thus, the sealing by means of the sealing tape may serve essentially to ensure that the welded seam in itself fulfils the waterproof requirement, while the fabric close to the seam has maintained its waterproofness also after the welding of the seam has been performed.

It is noted that by the invention the attaching of the at least two pieces of fabric may be made in such a manner that it may be avoided using any additional materials being added for facilitating the welding as is the case according to the prior art of EP 2454958 A1. Thus, the method according to the invention may provide a cost-efficient method. Further, since additional materials, e.g. meltable strips of hydrostatic polymers, are avoided, the seam will not comprise any amount of such melted and later hardened additional material, which might otherwise cause the seam to be relatively voluminous and stiffened as compared to the fabrics in general, Thus, it may furthermore be achieved that the welded seam and the attached fabrics in general will not differ considerably from the fabrics prior to the welding process having been performed.

In an advantageous embodiment of the invention, the welded fabric may form part of a footwear, e.g. a footwear upper, and the welded fabric may be included as a lining of an upper that comprises e.g. an outwardly facing breathable leather or textile surface. The fabric including a functional layer may thus preferably face inwardly in the footwear and either form a lining of the footwear or form part of the lining, e.g. being included between a leather or textile layer of the upper and a lining of the inside of the footwear.

The welded fabric should preferably be welded and subsequently attached to the upper by stitching (e.g. at the very top-part of the footwear) and gluing/molding at the lower end to the sole. Whatever way of attaching the fabric to the footwear chosen, the chosen way should ensure that a desired purpose of a combined waterproofness and breathability is fulfilled.

A waterproof and vapor permeable membrane including a functional layer is well known within the art, such as commercially available GORE-TEX® laminate from W. L. Gore & Associates, Sympatex, Cosmo, Outdry, Covestro, Respilon, Schoeller or Wilhelm.

According to an embodiment, said welding process may be an ultrasonic welding process.

Hereby, it may be achieved that the welding of the seam may be performed in a manner that is expedient as regards the welding of fabrics, where it is desired that essentially only a very small area of the fabrics is influenced, e.g. heated, in order to maintain the characteristics of the fabrics at areas close to the seam, e.g. characteristics such as waterproofness, vapour permeability, etc.

It is noted that other welding processes may be used such as e.g. laser welding or other suitable welding techniques.

Furthermore, it is noted that the ultrasonic welding process may involve providing ultrasonic energy or vibrations at frequencies of for example 15 kHz or above, 20 kHz or above, 30 kHz or above, 35 kHz or above, 40 kHz or above, 70 kHz or above.

According to an embodiment, each of said at least two pieces of fabric may comprise a weldable synthetic composition having a weldable fabric composition higher than 30%.

Hereby, the attaching of the fabrics may effectively be performed by use of an ultrasonic welding technique, when the fabrics comprise such a percentage higher than 30% of ultrasonic weldable compositions, e.g. fiber elements, web, mesh, threads, materials, etc., and whereby a welded seam may be provided having a suitable strength. The weldable composition may comprise a part of the fabric which is not regarded as the so-called functional layer (which is both waterproof and weldable) or if at all possible, the weldable composition may even include at least part of the so-called functional layer of the membrane fabric.

According to further embodiments, at least one of said at least two pieces of fabric may comprise a weldable synthetic composition having a weldable fabric composition higher than 40%, such as higher than 50%, such as higher than 60% or such as higher than 70%.

Hereby, the attaching of the fabrics may effectively be performed by use of an ultrasonic welding technique, when the fabrics comprise such percentages of ultrasonic weldable compositions, e.g. fiber elements, web, mesh, threads, materials, etc., and whereby a welded seam may be provided having a suitable strength. The weldable composition may comprise a part of the fabric which is not regarded as the so-called functional layer (which is both waterproof and weldable) or if at all possible, the weldable composition may even include at least part of the so-called functional layer of the membrane fabric.

It is noted that according to an embodiment, said at least two pieces of fabric may each comprise a weldable synthetic composition having a weldable fabric composition higher than 40%, such as higher than 50%, such as higher than 60% or such as higher than 70%.

According to an embodiment, said weldable fabric composition may comprise a thermoplastic polymer material.

According to an embodiment, said weldable fabric composition may comprise a plastic material that is meltable by application of ultrasonic energy.

According to an embodiment, said weldable fabric composition may comprise a plastic material that may be softened by application of ultrasonic energy.

As examples, it is noted that said weldable fabric composition may comprise a plastic material such as one or more of Polyamide, Polyester, Elastane, Polyurethane, Polyacrylate, etc. Further examples are mentioned below.

According to an embodiment of the invention, the at least two pieces of fabric may be attached directly to each other by the welding process to form a welded seam.

Hereby, the attaching of the fabrics may be performed in a flexible and cost-efficient manner, e.g. without requiring additional material for effecting the welding process to form a welded seam and without requiring additional steps to position additional materials e.g. between or near the at least two pieces of fabric prior to or e.g. in connection with the welding being performed. Furthermore, since no additional material for effecting the welding process is utilized, a welded seam having characteristics that may not differ significantly from the surrounding fabric may be produced. Thus, a combined fabric being made from two or more pieces of fabric, attached by a seam, may be relatively homogenous, e.g. as regards pliability, flexibility and similar characteristics and may not be hampered by a relatively stiff seam.

According to an embodiment, said at least two pieces of fabric may form a membrane in a waterproof fabric product, said waterproof fabric product being a waterproof footwear construction.

Hereby, a waterproof fabric product may be provided in the form of a waterproof footwear construction, e.g. a shoe, which product comprises a membrane that has a desired waterproofness and which furthermore may possess vapour permeability characteristics, e.g. having breathability characteristics.

According to an embodiment, said step of attaching the at least two pieces of fabric by said welding process to form a welded seam may comprise positioning the at least two pieces of fabric on top of each other and performing a seam welding.

Hereby, the attaching of the fabrics may be performed in a precise and efficient manner, e.g. by performing an ultrasonic welding and cutting, e.g. by a sonotrode wheel and corresponding anvil wheel, while passing the at least two pieces of fabric through an operative space between the welding wheels, e.g. a sonotrode wheel and an anvil wheel, e.g. arranged on/in a work table.

In case the weldable fabric composition varies in the transversal direction of one or more of the fabrics, the at least two pieces of fabric may be oriented such that when being arranged on top of each other prior to the seam welding, the surfaces having the higher percentage of weldable fabric composition may be facing each other in order to improve the efficiency of the welding and/or the desired quality of the welded seam.

According to an embodiment, said seam welding may be applied by an ultrasonic welding machine, whereby said at least two pieces of fabric are subjected to ultrasonic energy at an area along said at least two pieces of fabric.

Hereby, the welding of the seam may be performed in an expedient and cost-efficient manner, wherein only a very small area of the fabrics is influenced, e.g. heated, and whereby characteristics of the fabrics at areas even close to the seam are maintained, e.g. characteristics such as waterproofness, vapour permeability, etc. In particular, it is noted that e.g. damaging effects to the waterproofness may be avoided in contrast to what is the case in connection with prior art techniques where stitching is applied.

According to an embodiment, fabric outside an allowance A in relation to said welded seam of said at least two pieces of fabric may be cut off.

Hereby, a trimming of the fabrics is achieved, e.g. simultaneous with the ultrasonic welding, whereby a seam structure may be achieved that allows the at least two pieces of fabric to be more or less unfolded, thereby providing an e.g. planar construction stretching from the seam to both sides or providing an angled construction.

According to an embodiment, said allowance A may be in the range of 1 to 3 mm, 1 to 5 mm, 1 to 10 mm or more.

According to an embodiment, said at least two pieces of fabric may, subsequent to being attached by said welded seam, be unfolded in relation to said welded seam before said sealing tape is applied.

Hereby, it may be achieved that the combined fabric essentially may serve as an e.g. planar piece of fabric, since the welded seam, even though performed with the at least two pieces of fabric laying on top of each other, will function as an edge to edge welding of the two fabrics, e.g. due to the materials at a very small area only will be affected by the welding energy, e.g. the ultrasonic energy. Thus, the welded seam may be unfolded (as indicated in FIGS. 3 and 7) to in practice be essentially planar and without leaving any significant ridge or similar traces of the welding seam.

According to an embodiment, said at least two pieces of fabric may be unfolded in relation to said welded seam to provide a plane before said sealing tape is applied.

Thus, it is noted that the sealing tape may be applied in a fashion, whereby it readily can be applied to the least two pieces of fabrics at a planar area on both sides of the welded seam, such that the sealing tape will be contacting the fabrics over the entire sealing area.

According to an embodiment, said at least two pieces of fabric may be unfolded in relation to said welded seam to form an angle before said sealing tape is applied.

Due to the flexibility of the welded seam the combined fabrics may be formed or folded/unfolded in various manners as the combined fabrics will not be hampered with e.g. a relatively stiff and complex seam as otherwise might be the case with some prior art techniques.

According to an embodiment, said sealing tape may have a width that is less than 22 mm, such as 15 mm or less, such as 11 mm or less or such as 8 mm or less.

Hereby, a number of advantages may be achieved as compared to the prior art, e.g. including reduced material costs, improved vapour permeability of the membrane, e.g. due to a smaller area of the fabrics being covered by a potential vapour permeability hindrance. Also less gathering or shrinking of the fabrics may be achieved, which gathering or shrinking is due to the sealing tape being applied to a curved construction. When applied to a convex curved construction, the edge of the sealing tape will be shorter than the centre of the sealing tape, when the tape is applied to the “ridge”. This will be compensated at one end of the construction, e.g. at the bottom of a shoe membrane construction, thus effecting a gathering. This gathering will be reduced or possibly even avoided, when the width of the sealing tape is reduced. Thus, by this embodiment, a considerable effect is achieved as regards the reduction of gathering.

According to an embodiment, said sealing tape may be a 2-layer heat seal tape.

According to a further embodiment, said sealing tape may be a 3-layer sealing tape.

Hereby, a number of advantages may be achieved as compared to the prior art.

For example, a sealing tape in the form of a 2-layer heat seal tape may be used, e.g. a heat seal tape having a layer of coated fabric, which on one side has a layer of heat seal polyester, which may be applied to the welded fabrics by application of heat. Such a tape may represent substantial material cost reductions in comparison to the prior art.

Another example of a suitable sealing tape is a sealing tape of a type as described in connection with the prior art, i.e. a 3-layer sealing tape comprising a rear mesh, a membrane and a layer of adhesive, which may be applied to the welded fabrics by application of heat to the layer of adhesive, but where the width may be reduced considerably, e.g. to a width W of for example 11 mm or less, thereby inducing cost reductions.

According to an embodiment, said at least two pieces of fabric may comprise a first piece of fabric and a second piece of fabric, wherein said first piece of fabric is a first type of fabric and wherein said second piece of fabric is a second type of fabric, which differs from said first type of fabric as regards one or more characteristics

According to a further embodiment comprising at least two pieces of fabric comprising a first piece of fabric and a second piece of fabric, said second piece of fabric may differ from said first type of fabric as regards one or more characteristic relating to
thickness,
composition and/or
vapour permeability.

It is noted, though, that the at least two pieces of fabric may be similar or identical to each other as regards one or more of the characteristics.

According to an embodiment, said fabric may comprise a functional layer providing waterproofness and breathability layered, printed or coated onto and/or into said fabric.

In an advantageous embodiment of the invention, the welded fabric forms part of a footwear, e.g. a footwear upper, and the welded fabric may be included as a lining of an upper comprising e.g. an outwardly facing breathable leather or textile surface. The fabric including a functional layer may thus preferably face inwardly in the footwear and either form a lining of the footwear or form part of the lining, e.g. including between a leather or textile layer of the upper and lining of the inside of the footwear.

The welded fabric should preferably be welded and subsequently attached to the upper by stitching (e.g. at the very top-part of the footwear) and gluing/molding at the lower end to the sole. Whatever way of attaching the fabric to the footwear chosen, the chosen way should ensure that a desired purpose of a combined waterproofness and breathability is fulfilled.

The invention relates according to a second aspect to a waterproof fabric product having been produced using the method of attaching at least two pieces of fabric in a waterproof fabric product according to any one of claims 1-19.

The invention relates according to a third aspect to a footwear comprising a membrane wherein the membrane comprises at least two pieces of fabric that are attached at a seam, said seam being sealed by a sealing tape, said seam being a welded seam and said sealing tape having a width that is less than 22 mm, such as 15 mm or less, such as 11 mm or less or such as 8 mm or less.

According to an embodiment, said at least two pieces of fabric may be attached directly to each other at said welded seam.

Hereby, the attaching of the fabrics of the membrane of the footwear may be performed in a flexible and cost-efficient manner, e.g. without requiring additional material for effecting the welding process to form a welded seam and without requiring additional steps to position additional materials e.g. between or near the least two pieces of fabric prior to or e.g. in connection with the welding being performed. Furthermore, since no additional material for effecting the welding process is utilized, a welded seam having characteristics that may not differ significantly from the surrounding fabric may be produced. Thus, a combined fabric of the membrane being made from two or more pieces of fabric, attached by a seam, may be relatively homogenous, e.g. as regards pliability, flexibility and similar characteristics and may not be hampered by a relatively stiff seam. Thus, the membrane of the footwear may according to this embodiment furthermore be provided in a manner meeting user comfort requirements as well as requirements concerning e.g. waterproof requirements and cost efficiency.

According to an embodiment, said at least two pieces of fabric may be attached to each other at said welded seam by an ultrasonically welded seam.

Hereby, the welding of the seam may be performed in an expedient and cost-efficient manner, wherein only a very small area of the fabrics of the membrane of the footwear is influenced, e.g. heated, and whereby characteristics of the fabrics at areas even close to the seam are maintained, e.g. characteristics such as waterproofness, vapour permeability, etc. In particular, it is noted that e.g. damaging effects to the waterproofness may be avoided in contrast to what is the case in connection with prior art techniques where stitching is applied, and thus, the membrane of the footwear may be provided in an expedient and cost-efficient manner, while meeting the demands regarding e.g. comfort and user-friendliness.

According to an embodiment, the membrane comprising at least two pieces of fabric may have been attached using the method of attaching at least two pieces of fabric in a waterproof fabric product according to any one of claims 1-19.

### THE FIGURES

The invention will be explained in further details below with reference to the FIGS. of which

FIGS. 1a-1c illustrate an example of a waterproof fabric product according to a prior art,

FIG. 2 illustrates an example of a 3-dimensional (3D) waterproof fabric product according to a prior art,

FIG. 3 shows two pieces of waterproof fabrics that are attached in a waterproof fabric product according to an embodiment of the invention,

FIG. 4 shows an example of a 3-dimensional (3D) waterproof fabric product according to an embodiment of the invention,

FIG. 5 is a schematically illustrated ultrasonic welding machine for welding of fabrics,

FIG. 6 shows an ultrasonic welding wheel arrangement in an enlarged view,

FIG. 7 illustrates two pieces of fabric assembled in order to be seam welded along one of the edges,

FIG. 8 shows in an enlarged scale an example of an ultrasonic anvil wheel in an exploded view,

FIG. 9 illustrates an exemplary embodiment of the application of a sealing tape, and

FIGS. 10a,b show a waterproof fabric product for a piece of footwear, wherein advantages of using a relatively slim sealing tape is illustrated.

### DETAILED DESCRIPTION

In an advantageous embodiment of the invention, the fabric to be gathered by welding and sealed with a sealing tape may be referred to as a membrane or a so-called functional layer within the scope of the invention. The understanding of a membrane and a functional layer will in most applications be basically the same. The membrane/functional layer may in theory be a fabric as such, but it may be part of a fabric, added as a layer to a reinforcing fabric, coated onto a fabric as long as the fabric as such serves the intended purposes. Unless otherwise stated, the term membrane will refer to a composite or a membrane structure combined with a reinforcing structure, together forming a fabric which is both waterproof and breathable.

In order to avoid confusing the use of wording membrane of the present application (including a reinforcing fabric) with the membrane as isolated functional layer/structure/member, the below explanation will refer to this layer as a functional layer.

In one embodiment of the invention, a functional layer which is not only water-impermeable but also water-vapour-permeable is used. This makes it possible to produce waterproof shoes which remain breathable in spite of the waterproofness.

Suitable materials for the waterproof, water-vapour-permeable functional layer are, in particular, polyurethane, polypropylene and polyester, including polyether esters and their laminates, as described in the publication U.S. Pat. No. 4,493,870. Particularly preferred, however, is expanded microporous polytetrafluoroethylene (ePTFE), as described for example in the publications U.S. Pat. Nos. 3,953,566 and 4,187,390, and expanded polytetrafluoroethylene which is provided with hydrophilic impregnating agents and/or hydrophilic layers; see for example the publication U.S. Pat. No. 4,194,041. A microporous functional layer is understood to mean a functional layer of which the average pore size lies between approximately 0.2 microns and approximately 0.3 microns.

The pore size can be measured with the Coulter Porometer (trade name), which is produced by Coulter Electronics, Inc., Hialeath, Fla., USA.

A functional layer is regarded as “waterproof”, if appropriate including the seams provided at the functional layer, if it ensures a water ingress pressure of at least 1*10<4>Pa. The material of the functional layer preferably ensures a water ingress pressure of over 1*10<5>Pa. The water ingress pressure is measured by a test method in which distilled water at 20±2[deg.] C. is applied with increasing pressure to a sample of the functional layer of 100 cm<2>. The pressure increase of the water is 60±3 cm of water column per minute. The water ingress pressure then corresponds to the pressure at which water appears on the other side of the sample for the first time. Details of the procedure are described in ISO standard 0811 from the year 1981.

A functional layer is regarded as “water-vapour-permeable” if it has a water-vapour permeability coefficient Ret of less than 150 m<2>*Pa*W<−1>. The water-vapour permeability is tested by the Hohenstein skin model. This test method is described in DIN EN 31092 (February/1994) or ISO 11092 (1993).

Whether a shoe is waterproof can be tested for example by a centrifuge arrangement of the type described in U.S. Pat. No. 5,329,807.

If ePTFE is used as the functional layer, the reactive hot-melt adhesive can penetrate into the pores of this functional layer during the cementing operation, which leads to a mechanical anchoring of the reactive hot-melt adhesive in this functional layer. The functional layer consisting of ePTFE may be provided with a thin polyurethane layer on the side with which it comes into contact with the reactive hot-melt adhesive during the cementing operation. If PU reactive hot-melt adhesive is used in conjunction with such a functional layer, there occurs not only the mechanical bond but also a chemical bond between the PU reactive hot-melt adhesive and the PU layer on the functional layer. This leads to a particularly intimate adhesive bonding between the functional layer and the reactive hot-melt adhesive, so that particularly durable waterproofness is ensured.

In the below explanation the term fabric, when designated a fabric having the function as serving as a waterproof membrane, such fabric will include both a fabric and a functional layer as explained with respect to function above. Other types of fabrics applicable may e.g. include a layered product as disclosed in WO2018153423.

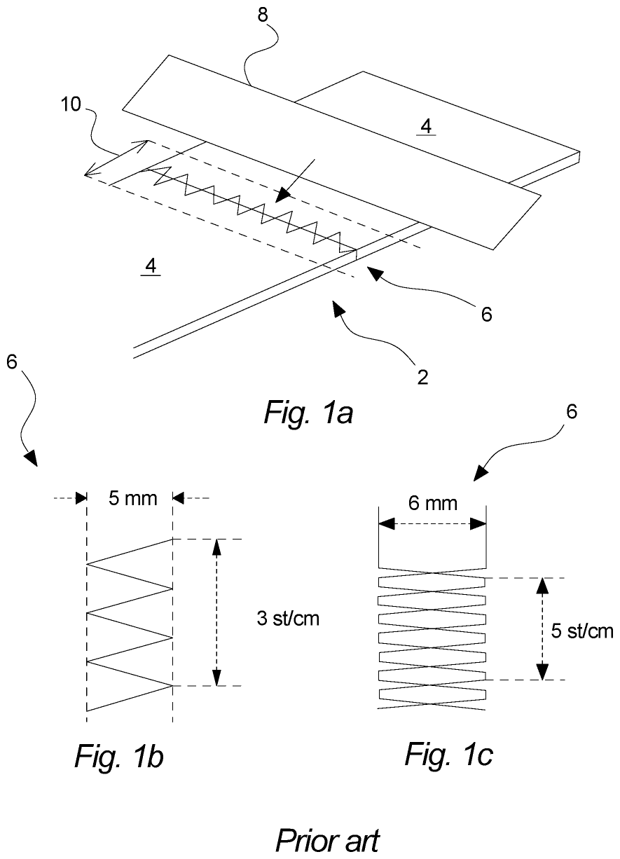

FIG. 1a illustrates an example of a waterproof fabric product 2 according to a prior art, where two pieces of fabric 4, which each serve as a waterproof membrane, are attached to each other in order to form the waterproof fabric product, i.e. a waterproof membrane in a waterproof fabric product. The two pieces of fabric 4 have, after a possible cutting of the edges to form a predefined shape, been positioned edge to edge and have been attached together by a stitching 6. The stitching 6 may be performed according to e.g. instructions, manuals etc. for example from a supplier of the fabric(s). In FIG. 1a the stitching is shown as a zigzag stitching, which is furthermore illustrated in FIG. 1b, where furthermore it is shown that the stitching 6 has a width of 5 mm and has 3 stiches per cm. FIG. 1c shows a further stitching 6 that can be used according to this example, i.e. a flatlock stitching having a width of 6 mm and having 5 stiches per cm. In order to fulfil the instruction from e.g. the supplier of the waterproof fabrics, the stitching area must subsequently be sealed with a sealing tape 8 having a width 10 of 22 mm, thus in the example with the zigzag stitching giving in theory an allowance of 8.5 mm on each side of the stitching width. However, due to variations of the e.g. stitching, the allowance may be smaller, but as a minimum an allowance of 6 mm on each side is required in practice.

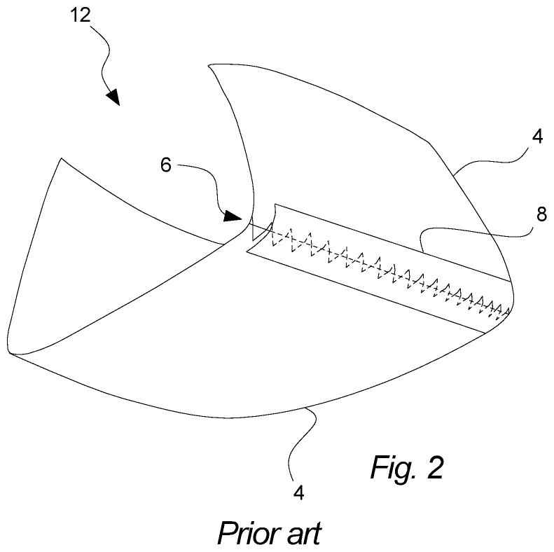

FIG. 2 illustrates an example of a 3-dimensional (3D) waterproof fabric product 12 according to a prior art, e.g. for example a cut-out of a waterproof fabric product, i.e. a waterproof membrane in a waterproof fabric product to be included in for example a piece of footwear, thus illustrating a part for the bottom and side parts. Here, it is illustrated that two pieces of fabric 4, which each serve as a waterproof membrane, are attached to each other in order to form the waterproof fabric product, i.e. a waterproof membrane in a waterproof fabric product. The two pieces of fabric have been positioned edge to edge and have been connected by stitching, e.g. by a 5 mm zigzag stitching. Subsequently, a prior art sealing tape 8 has been applied on top of the stitching, attached by an adhesive on one side of the sealing tape.

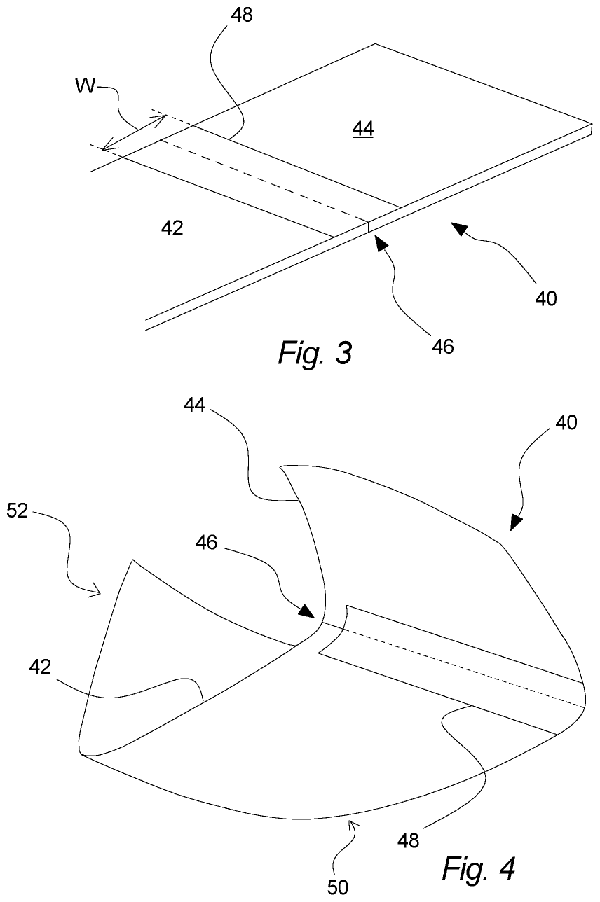

FIG. 3 shows a first piece of fabric 42 and a second piece of fabric 44 that are attached in a waterproof fabric product 40 in accordance with an embodiment of the invention. The two pieces of fabric 42, 44 have been attached edge to edge by means of a welding process, e.g. an ultrasonic welding technique, which furthermore may include a simultaneous cutting of the edges. Such a welding process attaching two pieces of fabric edge to edge will be elucidated further below. Subsequently, a sealing tape 48 having a width W has been applied to one side of the welded seam 46, e.g. in order to ensure waterproofness and/or to enforce the strength of the welded seam 46.

In FIG. 4, an example of a 3-dimensional (3D) waterproof fabric product 40 according to an embodiment of the invention is illustrated, where the 3D waterproof fabric product 40 illustrated in FIG. 4 may for example be a part of a waterproof membrane to be included in for example a piece of footwear, thus illustrating a bottom 50 of the waterproof fabric product and side elements 52 of the waterproof fabric product, e.g. a piece of footwear. Here, it is illustrated that two pieces of fabric 42 and 44, which each serve as a waterproof membrane, are attached to each other at a welded seam 46, which is covered by a sealing tape 48.

The sealing tape 48 may be a tape selected from a wide variety of tapes that can be applied to the fabrics and which may be slimmer, i.e. having a smaller width W, than the sealing tapes used according to the prior art sealing technique.

Thus, for example a sealing tape in the form of a 2-layer heat seal tape may be used, e.g. a heat seal tape having a layer of coated fabric, which on one side has a layer of heat seal polyester, which may be applied to the welded fabrics by application of heat. Such a sealing tape may for example have a width W of 15 mm.

Another example of a suitable sealing tape is a sealing tape of a type as described in connection with the prior art, i.e. a 3-layer sealing tape comprising a rear mesh, a membrane and a layer of adhesive, which may be applied to the welded fabrics by application of heat to the layer of adhesive, but where the width is reduced considerably, e.g. to a width W of for example 11 mm or less.

In this connection it is noted that the reduced width of the sealing tape 48 as compared to the sealing tape of the above-cited prior art may in itself entail various advantages, e.g. including reduced material costs, improved vapour permeability of the membrane, less gathering or shrinking of the fabrics as it later will be described, etc.

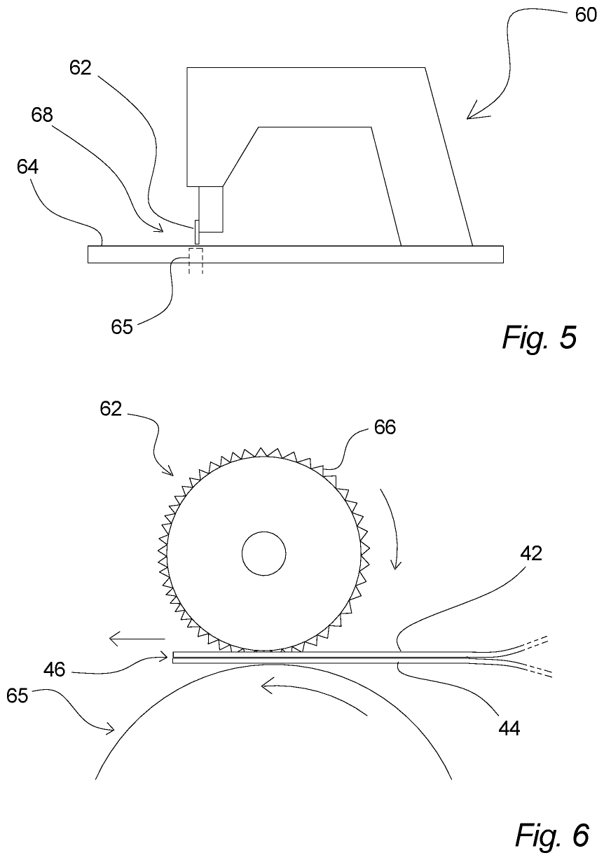

FIG. 5 shows a schematically illustrated ultrasonic welding machine 60, by means of which fabrics may be welded and cut as it later will be explained. The ultrasonic welding machine 60, which may for example be a Vetron Ultrasonic Welding Machine 5064, comprises ultrasonic welding wheels 68. These ultrasonic welding wheels 68 comprise in this example an ultrasonic anvil wheel element 62 and a sonotrode wheel 65, which is a rotatable wheel, a part of which is schematically shown with dash lines in FIG. 5, and which is the source of the ultrasonic energy for the welding. Further, a work table 62 is illustrated, which serves for positioning one or more fabrics in relation to the ultrasonic welding wheels 68 and for advancing the one or more fabrics while being subjected to an ultrasonic welding.

FIG. 6 shows the ultrasonic welding wheels 68 in an enlarged view, seen from the side, where it is further shown that the ultrasonic anvil wheel 62 comprises a pulling toothing 66, e.g. a toothed wheel for advancing the fabric(s), while the ultrasonic anvil wheel 62 and the sonotrode wheel 65 are rotating as indicated by the arrows.

In FIG. 6 it is furthermore shown that a first piece of fabric 42 have been positioned on top of a second piece of fabric 44 in order for the two pieces of fabric to be attached to each other by ultrasonic welding. Thus, the two pieces of fabric are being advanced and fed in between the ultrasonic anvil wheel 62 and the sonotrode wheel 65 that are rotating and whereby the two pieces of fabric 42 and 44, when passing, will be subjected to the ultrasonic energy at an area along the fabrics, whereby a welded seam 46 will be made by the ultrasonic welding, e.g. due to weldable material of the two fabrics being softened and/or melted at a seam. Further, the fabrics will be advanced by the pulling of the pulling toothing 66 of the ultrasonic anvil wheel 62 and will thus be advanced as illustrated by the arrow. Further, it is noted that a cut is made by the ultrasonic anvil wheel 62, e.g. whereby a trimming of the edges of the fabrics is performed.

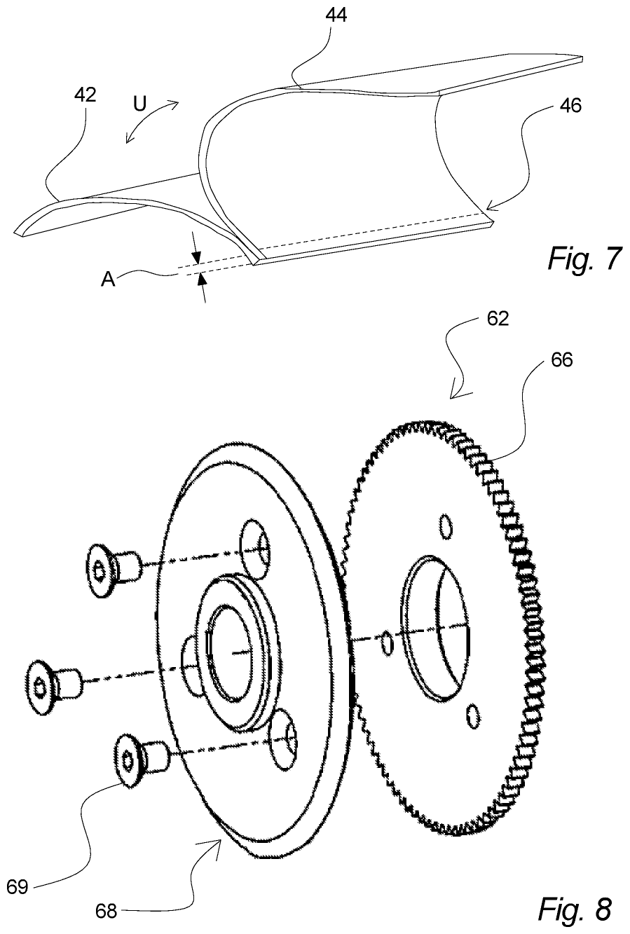

In FIG. 7 it is illustrated that the two pieces of fabric 42 and 44 have been placed on top of each other in order to perform a seam welding along one of the edges, e.g. the welded seam 46 as illustrated by the dash line. The fabrics are welded edge to edge by trimming off a gap. Thus, as shown, the use of the ultrasonic welding machine 60 comprising the ultrasonic anvil wheel element 62 and the sonotrode wheel 65 requires an allowance A, e.g. the gap being trimmed off and an allowance for the pulling toothing 66 to advance the fabric(s), which allowance must be at least around 3.3 mm. Thus, the trimming represents a reasonably small waste. As illustrated by the arrow U, the fabrics 42 and 44 may be unfolded after the welding process, whereby the two pieces of fabric 42 and 44 may extend e.g. in general in a plane as illustrated in FIG. 3 or in any desired angle (cf e.g. FIG. 4).

Subsequent to such an unfolding, a sealing tape may be applied, as it later will be illustrated.

It has been realized that by the ultrasonic welding of the fabrics an attachment of the fabrics is achieved, whereby the characteristics of the membranes, e.g. the waterproofness, the vapour permeability, etc. are maintained. By the machinery, e.g. the processing by means of the wheels and puller of the ultrasonic welding machine, handling and operations performed on the fabrics, whereby no perforations are made in the membrane and whereby the membrane is not exerted to any other damaging effects.

It should be noted that the orientation of the applied membrane fabric should preferably be oriented so that the surfaces oriented towards each other during a welding, e.g. a ultrasonic welding, are weldable.

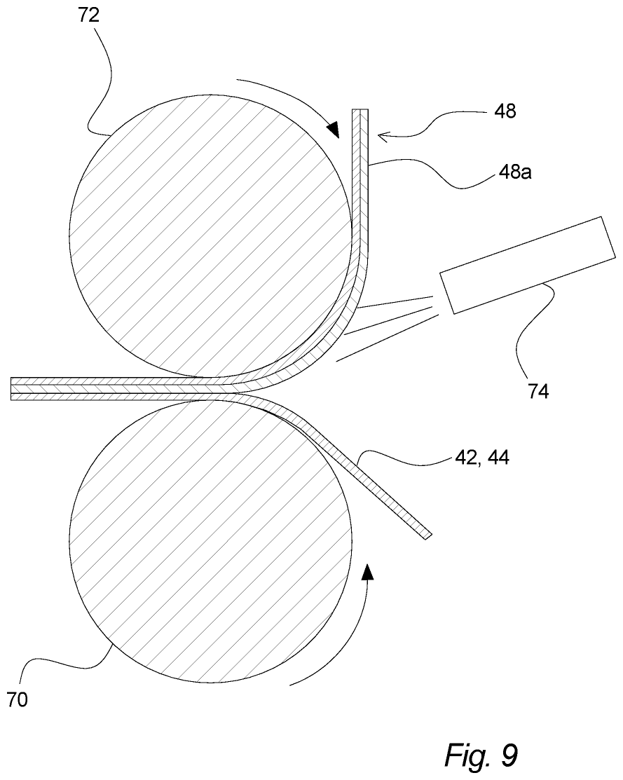

FIG. 8 shows in an enlarged scale an example of an ultrasonic anvil wheel 62, which on one side comprises the pulling toothing 66 that by means of fastening elements 69 such as screw elements are fixed to the ultrasonic welding wheels 68 that together with the sonotrode wheel 65 effect the ultrasonic welding and the cutting of the fabric(s), e.g. near the welding seam.

In FIG. 9 an exemplary embodiment of the application of a sealing tape 48 is illustrated. Here, it is shown that a first piece of fabric 42 and a second piece of fabric 44 that have been attached to each other by means of a welding process at a welded seam 46 (not shown in FIG. 9) are led in between a lower roller 70 and an upper roller 72, while a sealing tape 48 is applied to the area of the welded seam. The sealing tape 48 has at one side an application layer 48a that faces the welded seam, which application layer 48a due to e.g. heat applied by a hot air nozzle 74 attaches to the welded seam and the two pieces of fabric 42, 44 on each side of the welded seam. The application layer 48a may be a heat seal polyester, any other type of heat seal material, a glue material, etc. It is noted that pressure may be applied by the two rollers 70 and 72, e.g. in order to facilitate the sealing and a robust connection between the sealing tape 48 and the fabrics 42, 44.

It is noted that the sealing tape 48 as used in connection with the present invention has been illustrated in FIG. 9 as being a two layer tape, but in general it is noted that the sealing tape may be a two layer tape, a three layer tape or a tape having further layers. However, it is noted that the sealing tape may have a smaller width than the sealing tape as used in connection with the prior art and that the sealing tape need not comprise an impermeable membrane as is the case according to the prior art as mentioned above.

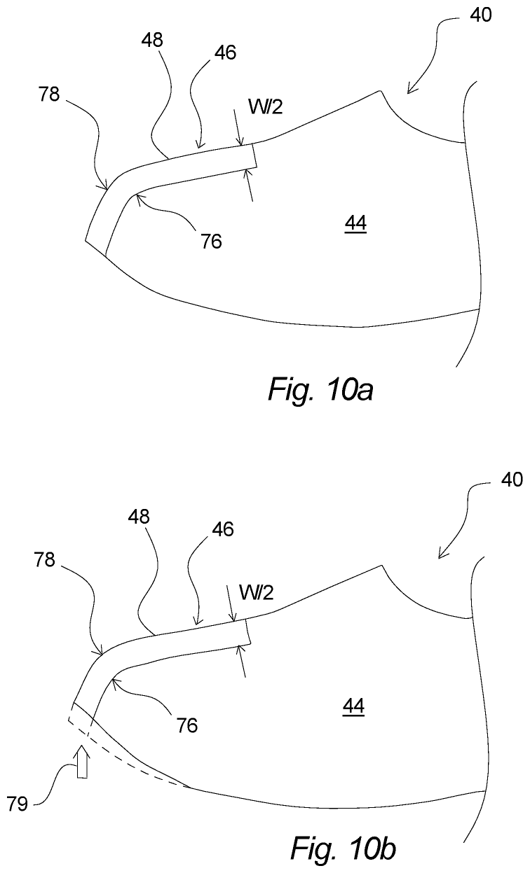

In FIG. 10a a waterproof fabric product 40 for a piece of footwear is shown, e.g. a waterproof layer for a shoe, wherein the product is seen from the side and where the 3D layer is folded e.g. along the middle of the shoe, and wherein only the toe part (to the left) and the middle part is shown. Thus, the e.g. second piece of fabric 44 is shown that via the welded seam 46 is attached to the first piece of fabric 42 (not visible in FIGS. 10a and 10b). Furthermore, it is shown that the sealing tape 48 is covering the welded seam 46. Further, it is shown that the sealing tape has a width W, thus meaning that the sealing tape 48 covers a width of W/2 on the visible side of the waterproof fabric product 40. Due to the curvature of the product 40 at the toe part, the length 76 of the edge of the sealing tape is shorter than the length 78 of the centre part of the sealing tape as illustrated in FIG. 10a. This makes the centre “gather”, which decreases the centre length 78, which has to be compensated in the bottom part of the product 40 as illustrated by the gathering (or shrinking) effect 79 as shown in FIG. 10b. In case a sealing tape has a width of 22 mm as in connection with the prior art, the length 78 of the centre part of the sealing tape would be around 99 mm and the length 76 of the edge of the sealing tape would be around 91 mm, thus giving a difference of around 8 mm (and a corresponding gathering effect 79). By the invention, whereby a relatively slim sealing tape can be used, the advantage may be achieved that the differences in centre length and edge length are smaller and that thus the gathering effect will be reduced and that the waterproof fabric product 40 for a piece of footwear will be fitting better.

In the above description, various embodiments of the invention have been described with reference to the drawings, but it is apparent for a person skilled within the art that the invention can be carried out in an infinite number of ways, using e.g. the examples disclosed in the description in various combinations, and within a wide range of variations within the scope of the appended claims.

### LIST OF REFERENCE NUMBERS

2 Prior art waterproof fabric product
4 Piece of fabric
6 Stitching
8 Prior art sealing tape
10 Prior art sealing tape width
12 3D prior art waterproof fabric product
40 Waterproof fabric product
42 First piece of fabric
44 Second piece of fabric
46 Welded seam
48 Sealing tape
48a Application layer
50 Bottom of waterproof fabric product
52 Side elements of waterproof fabric product
60 Ultrasonic welding machine
62 Ultrasonic anvil wheel
64 Work table
65 Sonotrode wheel
66 Pulling toothing
68 Ultrasonic welding wheels
69 Fastening element
70 Lower roller
72 Upper roller
74 Hot air nozzle
76 Length of edge of sealing tape
78 Length of centre of sealing tape
79 Gathering effect
A Allowance
U Unfolding
W Sealing tape width

1. A method of attaching at least two pieces of fabric in a waterproof fabric product, whereby the at least two pieces of fabric are attached at a seam and whereby the seam subsequently is sealed by application of a sealing tape, said method comprising:
attaching the at least two pieces of fabric to each other by a welding process to form a welded seam; and
performing said sealing by applying said sealing tape to cover said welded seam at one side of the fabric.

2. The method according to claim 1, whereby said welding process is an ultrasonic welding process.

3. The method according to claim 1, whereby each of said at least two pieces of fabric comprises a weldable synthetic composition having a weldable fabric composition higher than 30%.

4.-5. (canceled)

6. The method according to claim 1, whereby said at least two pieces of fabric form a membrane in a waterproof fabric product, said waterproof fabric product being a waterproof footwear construction.

7. The method according to claim 1, whereby said step of attaching the at least two pieces of fabric by said welding process to form a welded seam comprises positioning the at least two pieces of fabric on top of each other and performing a seam welding.

8. The method according to claim 5, whereby said seam welding is applied by an ultrasonic welding machine, whereby said at least two pieces of fabric are subjected to ultrasonic energy at an area along said at least two pieces of fabric, and
whereby fabric outside an allowance in relation to said welded seam of said at least two pieces of fabric is cut off.

9. (canceled)

10. The method according to claim 6, wherein said allowance is in the range of 1 to 3 mm.

11. The method according to claim 1, whereby said at least two pieces of fabric, subsequent to being attached by said welded seam, are unfolded in relation to said welded seam before said sealing tape is applied.

12.-13. (canceled)

14. The method according to claim 1, whereby said sealing tape has a width that is less than 22 mm.

15. The method according to claim 1, whereby said sealing tape is a 2-layer heat seal tape.

16. The method according to claim 1, whereby said sealing tape is a 3-layer sealing tape.

17. The method according to claim 1, whereby said at least two pieces of fabric comprise a first piece of fabric and a second piece of fabric, wherein said first piece of fabric is a first type of fabric and wherein said second piece of fabric is a second type of fabric, which differs from said first type of fabric as regards at least one characteristic.

18. (canceled)

19. The method according to claim 1, wherein said fabric comprises a functional layer providing waterproofness and breathability layered onto or into said fabric.

20. (canceled)

21. A footwear comprising a membrane wherein the membrane comprises at least two pieces of fabric that are attached at a seam, said seam being sealed by a sealing tape, said seam being a welded seam and said sealing tape having a width that is less than 22 mm.

22. The footwear according to claim 21, wherein the at least two pieces of fabric are attached directly to each other at said welded seam.

23.-24. (canceled)

25. The method according to claim 9, whereby said sealing tape has a width that is less than 11 mm.

26. A method of attaching at least two pieces of fabric in a waterproof fabric product, whereby the at least two pieces of fabric are attached at a seam and whereby the seam subsequently is sealed by application of a sealing tape, said method comprising:
attaching the at least two pieces of fabric to each other at the seam, and
performing said sealing by applying a 2-layer sealing tape to cover said seam at one side of the fabric.

27. The method according to claim 26, whereby said 2-layer sealing tape is a heat seal tape having a width that is less than 22 mm.

28. The method according to claim 26, whereby said 2-layer sealing tape comprises a coated fabric, said fabric having been coated by a layer of heat seal material.

29. The method according to claim 28, whereby said layer of heat seal material is heat seal polyester.
